(19) United States
(12) Patent Application Publication
(10) Pub. No.: US 2026/0099042 A1
(43) Pub. Date: Apr. 9, 2026

(54) METHOD FOR DESIGNING DIFFRACTIVE DEVICE AND METHOD FOR MANUFACTURING DIFFRACTIVE DEVICE

(71) Applicant: NTT, Inc., Tokyo (JP)

(72) Inventors: Masahiro Ueno, Tokyo (JP); Sohan Kawamura, Tokyo (JP); Takashi Sakamoto, Tokyo (JP); Masayuki Tsuda, Tokyo (JP)

(21) Appl. No.: 19/101,780

(22) PCT Filed: Aug. 9, 2022
(86) PCT No.: PCT/JP2022/030444

§ 371 Date: Feb. 6, 2025

(51) Int. Cl. G02B 27/00

(52) U.S. Cl. CPC G02B 27/0012

(57) ABSTRACT

An embodiment is a method including calculating an electric field distribution of an emission light on an emission plane of the diffractive element with respect to the incident light, the incident light being a Gaussian beam, calculating an electric field distribution obtained by multiplying an electric field distribution of emission light from the emission plane by a Gaussian window in a plane parallel to the emission plane located at a predetermined distance from the emission plane, as an electric field distribution of a beam approximated by a Bessel Gaussian beam, calculating a first electric field distribution as an electric field distribution on the emission plane of the diffractive element with respect to the electric field distribution of the emission light on the plane, and determining a depth of an unevenness on a surface of the diffractive element.

### CROSS-REFERENCE TO RELATED APPLICATIONS

This application is a national phase entry of PCT Application No. PCT/JP2022/030444, filed on Aug. 9, 2022, which application is hereby incorporated herein by reference.

### TECHNICAL FIELD

The present invention relates to a method for designing a diffractive element used for laser processing, rust removal and the like, and a method for manufacturing the same.

### BACKGROUND

High-power laser devices are used in wide range of applications, such as laser processing devices for cutting, and welding, and printing on metals, resins, and the like, and rust removal laser devices for removing rust from metals. In these high-power laser devices, it is necessary to reduce the size and weight of a portion that performs scanning of emission light, the so-called head portion. Therefore, attempts have been made to use a diffractive optical element (DOE, hereinafter referred to as a “diffractive element” or “DOE”) in the head portion of a laser processing device.

In particular, a kinoform is a diffractive element that only modulates the light phase and does not change the light intensity. Here, one of such having an unevenness structure on the surface of the substrate will be described.

FIG. 7 is a schematic view of an optical system in a case where an image is formed, using a diffractive element 30 of the related art. Light incident on the diffractive element 30 (arrow 1 in the drawing indicates an incident direction) is emitted from an emission surface P0 of the diffractive element 30, and the light emitted from the diffractive element 30 (an arrow 2 in the drawing indicates an emission direction) is condensed (image-formed) on an image formation surface P1.

Here, P₀ and P₁ are assumed to be parallel. In addition, it is assumed that an x-axis, a y-axis and a z-axis in the drawing are axes of a Cartesian coordinate system, and the coordinate origin is at P₀. A z-axis is an optical axis, and substantially coincides with a direction in which light emitted from the DOE 30 travels. The x-axis and the y-axis are orthogonal to the z-axis, and the xy plane is parallel to the P₀ plane and the P₁ plane. That is, the z-axis is orthogonal to the P₀ plane and the P₁ plane. In the drawing, u₀ and u₁ represent electric field distributions on P₀ and P₁, respectively.

When a z coordinate on P₀ is defined as z₀=0 and a z coordinate on P₁ is defined as z₁, a relation between u₀ and u₁ is expressed by equation (1) from the expression of Kirchhoff's diffractive integral (for example, NPL 1).

$$\begin{matrix}[ Math . 1 ] & \\ {u}_{1} ( {x}_{1} , {y}_{1} ) = \frac{j}{λ} \int {\int }_{- ∞}^{+ ∞} {u}_{0} ( {x}_{0} , {y}_{0} ) \cdot g ( {x}_{1} - {x}_{0} , {y}_{1} - {y}_{0} , {z}_{1} - {z}_{0} ) d {x}_{0} {dy}_{0} & ( 1 )\end{matrix}$$

In the equation, (x₀, y₀, z₀) and (x₁, y₁, z₁) are sets of coordinates of points on P₀ and P₁, j is an imaginary number unit, and λ is a wavelength of light. In addition, g(·) is a propagation function of light emitted from one point and is expressed by equations (2) to (4).

$$\begin{matrix}[ Math . 2 ] & \\ g ( x , y , z ) = \frac{1 + cos θ}{2} \cdot \frac{{e}^{- jkr}}{r} & ( 2 )\end{matrix}$$

$$\begin{matrix}[ Math . 3 ] & \\ r = \sqrt{{x}^{2} + {y}^{2} + {z}^{2}} & ( 3 )\end{matrix}$$

$$\begin{matrix}[ Math . 4 ] & \\ cos θ = \frac{z}{r} & ( 4 )\end{matrix}$$

Here, j is an imaginary number unit, and k is a wavenumber of light. Here, (1+cos θ)/2 is an inclination factor, which indicates an emission angle dependency from a DOE emission plane to each point of the electric field intensity on each point on the imaging plane.

Since a right side of equation (1) is a convolution integral of u₀ and g, when performing the Fourier transform on both sides of equation (1), it is expressed by equation (5).

$$\begin{matrix}[ Math . 5 ] & \\ {U}_{1} ( u , v ) = \frac{j}{λ} \cdot {U}_{0} ( u , v ) \cdot G ( u , ν ) & ( 5 )\end{matrix}$$

Here, each of U₁, U₀ and G is the Fourier transform of u₁, u₀, and g, and each of u and v represent spatial frequencies in the x-axis and y-axis direction.

U₀ from equation (5) is represented by equation (6).

$$\begin{matrix}[ Math . 6 ] & \\ {U}_{0} ( u , v ) = - j λ \cdot \frac{{U}_{1} ( u , v )}{G ( u , v )} & ( 6 )\end{matrix}$$

When both sides of equation (6) are subjected to inverse Fourier transform, u0 can be derived as shown in equation (7).

$$\begin{matrix}[ Math . 7 ] & \\ {u}_{0} ( x , y ) = - j λ \cdot {ℱ}^{- 1} [ \frac{{U}_{1} ( u , v )}{G ( u , v )} ] = - j λ \cdot {ℱ}^{- 1} [ \frac{ℱ [ {u}_{1} ( x , y ) ]}{ℱ [ g ( x , y ) ]} ] & ( 7 )\end{matrix}$$

Here, F[·] and F⁻¹[·] represent Fourier transform and inverse Fourier transform, respectively.

Thus, by designating the electric field distribution u₁ on the imaging plane P₁ and z-axis coordinate value z₁ on the imaging plane P₁, the electric field distribution u₀ on the DOE emission plane P₀ can be calculated.

Next, a method for designing unevenness to be formed on the surface of the DOE 30, using the electric field distribution u0 on the DOE emission plane P₀ will be described.

Here, it is assumed that the DOE 30 is of a transmission type, the DOE 30 is a rectangular parallelepiped dielectric having a uniform refractive index distribution, an unevenness shape on the DOE 30 is formed on one side of the rectangular parallelepiped dielectric, and square or rectangular pixels are arranged in a lattice shape.

The light is made incident from a surface on which the unevenness is formed or from its opposite surface, and the light is emitted from the surface opposite to the incident surface. In such a DOE 30, the electric field distribution u0 on the DOE emission plane P0 is formed according to a thickness of the dielectric in each pixel (an optical path length from the incident plane to the emission plane). Here, a case where the amplitude modulation of the electric field is not performed and only the phase modulation is performed (kinoform) in the DOE will be described.

FIG. 8 shows a relationship between the thickness of the transmissive DOE 30 and the phase of light at the DOE emission plane 32. A DOE internal refractive index is defined as n1, and a DOE external refractive index is defined as no (1 in air). Further, a step of the unevenness of the surface of the DOE 30 is defined as d, and it is assumed that the DOE 30 in the optical path A33 is thinner than the DOE 30 in the optical path B34 by a step (thickness) d. A point B is a point on the optical axis on the DOE emission plane 32 of the optical path B34, and a point a is an intersection point between a surface including the emission plane 32 of the optical path B34 and the optical axis of the optical path A33. A dotted line in the drawing indicates an equiphase plane 35 between the optical paths A33 and B34.

As shown in FIG. 8, when a plane wave is incident (in a direction of arrow 36), a phase difference Δφ at the point a when the phase at point B is defined as a reference (=0) is expressed by equation (8).

$$\begin{matrix}[ Math . 8 ] & \\ Δφ = - {k}_{0} d - ( - {k}_{1} d ) = d ( {k}_{1} - {k}_{0} ) = d ( \frac{2 π}{{λ}_{1}} - \frac{{2}_{π}}{{λ}_{0}} ) = \frac{2 π}{λ} d ( {n}_{1} - {n}_{0} ) & ( 8 )\end{matrix}$$

Here, k₁ and k₀ are the wavenumbers of the light inside the DOE 30 and outside the DOE 30, respectively, λ₁ and λ₀ are the wavelengths of the light inside the DOE 30 and outside the DOE 30, respectively, and λ is the wavelength of light in a vacuum.

When solving equation (8) with respect to d, it is represented by equation (9).

$$\begin{matrix}[ Math . 9 ] & \\ d = \frac{Δφ}{( {k}_{1} - {k}_{0} )} = \frac{λ}{2 π ( {n}_{1} - {n}_{0} )} Δφ & ( 9 )\end{matrix}$$

If the light incident on the DOE incident surface 31 is a plane wave, the phase of the DOE emission plane 32 is determined by an amount of depression (step of unevenness) D from the DOE emission plane 32. Since the phase difference Δφ of u₀ can be represented by a deflection angle arg(u₀) of u₀, the phase difference is represented by equation (10).

$$\begin{matrix}[ Math . 10 ] & \\ d ( x , y ) = \frac{arg ( {u}_{0} ( x , y ) )}{( {k}_{1} - {k}_{0} )} = \frac{λ}{2 π ( {n}_{1} - {n}_{0} )} arg ( {u}_{0} ( x , y ) ) & ( 10 )\end{matrix}$$

Here, since u₀ varies on the xy plane, an amount of depression (step in unevenness) from the DOE emission plane 32 is expressed as d(x, y).

When the thickness from the DOE incident surface 31 to the DOE emission plane 32 (thickness which becomes a reference of DOE 30) is defined as L₀, the thickness L(x, y) of the DOE 30 is expressed by equation (11).

$$\begin{matrix}[ Math . 11 ] & \\ L ( x , y ) = {L}_{0} - d ( x , y ) & ( 11 )\end{matrix}$$

Here, since arg(u₀) is usually in the range of 0 to 2π and −π to +π, d is 0 to λ/(n₁−n₀) and −λ/[2(n₁−n₀)] to +λ/[2(n₁−n₀)], respectively.

Since −jλ included in u₀ represented by equation (7) is a constant, u₀′ represented by equation (12) may be used instead of u₀ represented by equation (7).

$$\begin{matrix}[ Math . 12 ] & \\ {u}_{0}^{′} ( x , y ) = {ℱ}^{- 1} [ \frac{{U}_{1} ( u , v )}{G ( u , v )} ] = {ℱ}^{- 1} [ \frac{ℱ [ {u}_{1} ( x , y ) ]}{ℱ [ g ( x , y ) ]} ] & ( 12 )\end{matrix}$$

### CITATION LIST

### Non Patent Literature

[NPL 1] Joseph W. Goodman, “Introduction to Fourier Optics Second Edition”, McGROW-Hill Companiews Inc., 1996, pp. 32-53.

### SUMMARY

### Technical Problem

However, in the method for designing the unevenness formed on the surface of the DOE, since an imaging plane on which the electric field generated by the DOE can be designed to be is only the one surface P₁ and an emission range of light on the DOE emission plane P₀ forming a bright spot on the imaging plane P₁ is the whole surface of the DOE emission plane, it is not possible to perform design such that a diameter of the bright spot on the imaging plane P₁ can be maintained at a desired length in the optical axis direction.

Therefore, when the diffractive element designed by the above method is used for laser processing, rust removal or the like, the beam diameter cannot be held when the focal point of the beam is deviated in the optical axis direction. Thus, the accuracy of laser processing, the rust removal or the like is reduced, which causes a problem.

### Solution to Problem

In order to solve the above problem, a method for designing a diffractive element according to embodiments of the present invention is a method for designing a diffractive element for modulating a phase of incident light, using a computer, the method including: a first step of calculating an electric field distribution of an emission light on an emission plane of the diffractive element with respect to the incident light, the incident light being a Gaussian beam; a second step of calculating an electric field distribution obtained by multiplying an electric field distribution of emission light from the emission plane by a Gaussian window in a plane parallel to the emission plane located at a predetermined distance from the emission plane, as an electric field distribution of a beam approximated by a Bessel Gaussian beam; a third step of calculating a first electric field distribution as an electric field distribution on the emission plane of the diffractive element with respect to the electric field distribution of the emission light on the plane, on the basis of a principle of diffractive integral of Kirchhoff; and a fourth step of determining a depth of an unevenness on a surface of the diffractive element, on the basis of the electric field distribution on the emission plane of the diffractive element.

### Advantageous Effects

According to embodiments of the present invention, it is possible to provide a design method and a manufacturing method for a diffractive element capable of maintaining a diameter and a power of emission light over a predetermined length in a light propagation direction, and capable of performing processing of and rust removal on an object having a depth according to the emission light with high accuracy.

### BRIEF DESCRIPTION OF THE DRAWINGS

FIG. 1 is a diagram for explaining a method for designing a diffractive element according to a first embodiment of the present invention.

FIG. 2 is a diagram for explaining a method for designing a diffractive element according to a first embodiment of the present invention.

FIG. 3 is a flowchart for explaining the method for designing the diffractive element according to the first embodiment of the present invention.

FIG. 4 is a diagram for explaining a method for designing a diffractive element according to a first embodiment of the present invention.

FIG. 5A is a diagram for explaining the effects of the method for designing the diffractive element according to the first embodiment of the present invention.

FIG. 5B is a diagram for explaining the effects of the method for designing the diffractive element according to the first embodiment of the present invention.

FIG. 6 is a flowchart for explaining a method for designing a diffractive element according to a second embodiment of the present invention.

FIG. 7 is a diagram for explaining a method for designing a diffractive element of the related art.

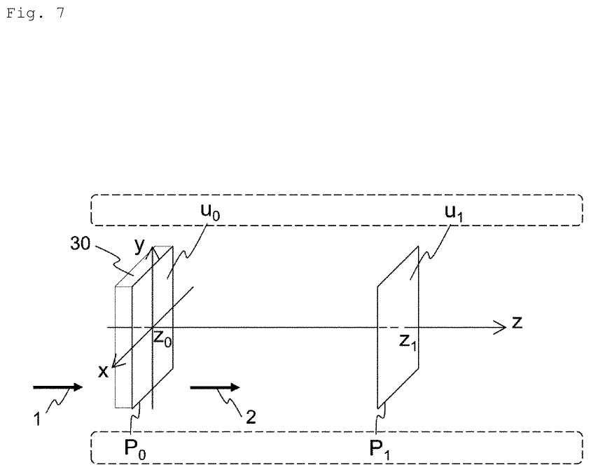

FIG. 8 is a diagram for explaining a method for designing a diffractive element of the related art.

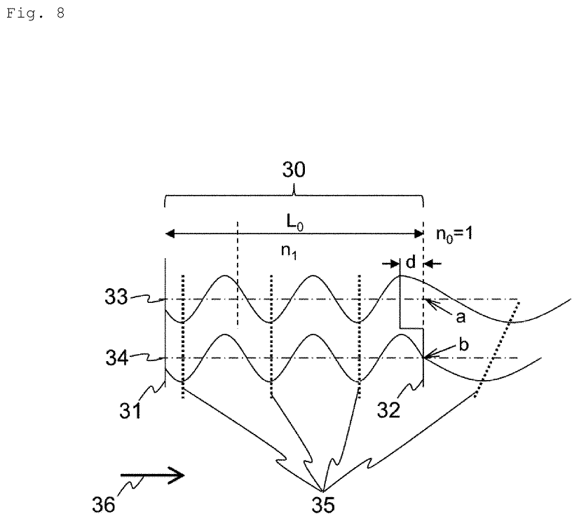

### DETAILED DESCRIPTION OF ILLUSTRATIVE EMBODIMENTS

### First Embodiment

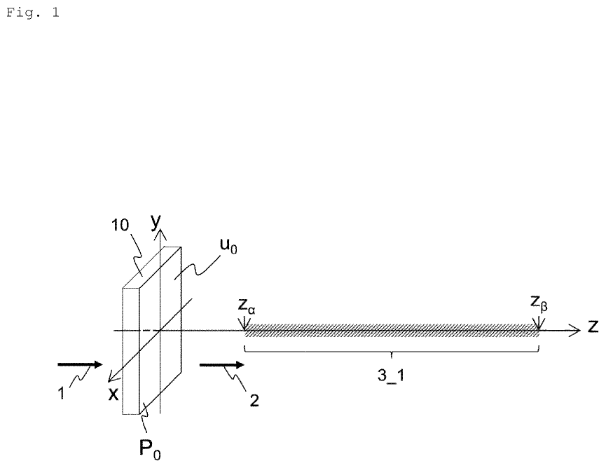

A method for designing a diffractive element and a method for manufacturing the same according to a first embodiment of the present invention will be described with reference to FIGS. 1 to 3.

### <Method for Manufacturing Diffractive Element>

A diffractive element 10 in the present embodiment is a so-called kinoform which does not perform an amplitude modulation of an electric field and performs only a phase modulation.

In the method for designing the diffractive element 10 according to the present embodiment, by determining an electric field distribution u₀ (first electric field distribution) on the emission plane P₀ of the diffractive element 10 that focuses (images) light in a predetermined range on the z-axis, a surface structure (unevenness structure) of the diffractive element 10 is designed. Here, the z-axis of the xyz coordinate system is perpendicular to the DOE emission plane P₀, and the coordinate origin is on the emission plane P₀.

FIG. 1 is a schematic view of an optical system in a case where an image is formed, using a diffractive element 10 in the present embodiment. Light incident on the diffractive element 10 (arrow 1 in the drawing indicates the direction of incidence) is emitted from the emission plane P₀ of the diffractive element 10, and light emitted from the diffractive element 10 (arrow 2 in the drawing indicates the direction of emission) is focused as a bright line 3_1 in a region between two points on the z-axis (for example, z_{α} and z_{β}). Here, the light emitted from the diffractive element 10 has a first electric field distribution ulo.

Here, x, y and z axes represent respective axes of a Cartesian coordinate system, and the DOE emission plane P₀ is parallel to the xy plane.

In the present embodiment, the method for designing the diffractive element for realizing Bessel Gaussian beams will be described. The Bessel Gaussian beam is a kind of pseudo non-diffracted light, and can maintain a beam diameter at a long distance. First, a Bessel beam, which is a non-diffracted light which is a basis of the Bessel Gaussian beam, will be described. Next, the Bessel Gaussian beam will be described. Finally, the method for designing the diffractive element for realizing the Bessel Gaussian beam will be described.

First, the Bessel beam will be described.

The Bessel beam can maintain a beam spot diameter over a long distance (theoretically, infinitely far) on the z-axis. An electric field distribution E_{B,z}(x, y) of the Bessel beam is shown by equation (13) and includes a Bessel function of the first kind and zero order. The electric field distribution has the maximum intensity on the z-axis, and is useful for use by condensing light such as a rust removing laser.

$$\begin{matrix}[ Math . 13 ] & \\ {E}_{B , z} ( x , y ) ∝ {e}^{j ( β z )} {J}_{0} ( α {r}_{xy} ) & ( 13 )\end{matrix}$$

Here, J₀ is a zero-order Bessel function of the first kind, r_{xy}=√(x²+y²), α=k sin φ_{B}, β=k cos φ_{B}, k is the wave number of light (k=2π/λ, λ is the wavelength of light), φ_{B} (hereinafter referred to as “convergence angle”) is a parameter that determines a beam diameter of a main lobe (lobe with intensity peak on the z-axis) of the Bessel beam (to be described later)

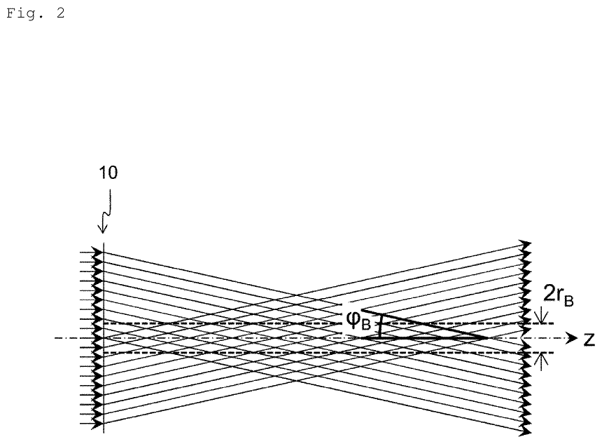

FIG. 2 shows the progress of light from the diffractive element (DOE) 10 when a Bessel beam having the z-axis as the center of the main lobe is formed. The Bessel beam is formed when the light of the same angle φ_{B} is advanced around the z-axis. The vessel beam has a main lobe and a side lobe, and the center of the z-axis is the center of the main lobe, and an annular side lobe is formed around the z-axis.

In the Bessel beam, as shown in FIG. 2, light is emitted from the emission plane of the diffractive element 10 to form an angle φB with respect to the z-axis at an arbitrary position of the z-axis. That is, light forming an angle φB with respect to the z-axis is emitted from an arbitrary point on P₀.

At this time, in a region in which the light emitted from the diffractive element 10 overlaps, the electric field distribution on a plane parallel to the xy plane is expressed by the equation (13). Here, since J0 is a Bessel function of the first class o order, it has a main lobe.

Here, overall width at half maximum 2rB and φB of the main lobe of the zero-order Bessel beam of the first kind are expressed by equation (14) (Wei. Ting Chen, Mohammadreza Khorasaninejad, Alexander Y. Zhu, Jaewon Oh, Robert C. Devlin, Aun Zaidi, and Federico Capasso, “Generation of wavelength-independent subwavelength Bessel beams using metasurfaces,” Light & Application, 6, el6259, 2017.).

$$\begin{matrix}[ Math . 14 ] & \\ {φ}_{B} = {sin}^{- 1} \frac{2.252728}{2 {r}_{B} k} = {sin}^{- 1} \frac{2.252728}{4 {r}_{B} π} λ & ( 14 )\end{matrix}$$

Therefore, when 2r_{B} which is the FWHM of the desired main lobe is determined, φ_{B} is calculated from the value by the equation 14.

A Bessel beam can be generated in a pseudo manner, by using an axicon lens (cone lens) as the diffractive element 10, and by making a plane wave or a collimated Gaussian beam incident on the axicon lens. At this time, as shown in FIG. 2, a region on which light is superimposed is formed on the emission side of the axicon lens, and a Bessel beam forming a main lobe on the z-axis of the region is generated.

Next, the Bessel Gaussian beam will be described. The Bessel Gaussian beam can limit the range of holding the beam diameter of the main lobe of the Bessel beam.

The electric field distribution E_{BG,z}(x, y) of the Bessel Gaussian beam is expressed by equation (15).

$$\begin{matrix}[ Math . 15 ] & \\ {E}_{BG , z} ( x , y ) ∝ {e}^{- {( \frac{{r}_{xy}}{w} )}^{2}} {e}^{j ( β z )} {J}_{0} ( α {r}_{xy} ) = {e}^{- {( \frac{{r}_{xy}}{w} )}^{2}} {E}_{B , z} ( x , y ) & ( 15 )\end{matrix}$$

In this way, the electric field distribution of the Bessel Gaussian beam is obtained by multiplying the Bessel beam expressed by equation (13) by the Gaussian window function exp[−(r_{xy}/w)²]. Here, w is half the width (half width) of the overall width at which the power of the Gaussian window function (the square of the electric field strength) is 1/e² with respect to the peak power (=1). Since equation (15) represents the electric field distribution, w in equation (15) is half the width (half width) of the overall width that is 1/e with respect to the peak value (=1) of the Gaussian window function.

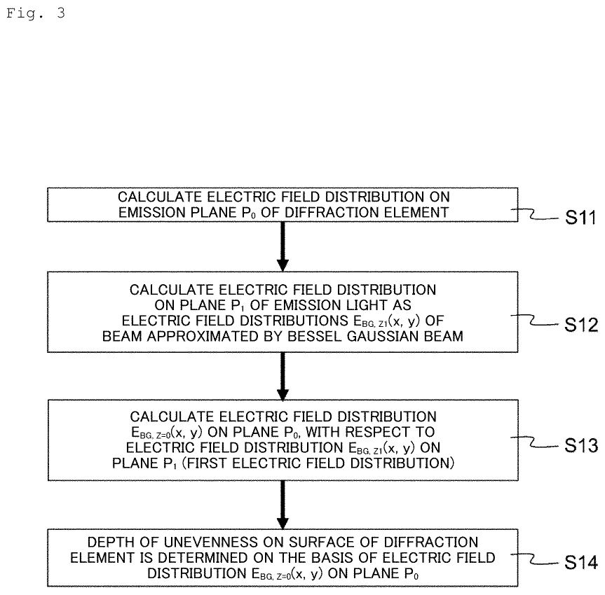

Finally, a method for designing a diffractive element for realizing a Bessel Gaussian beam will be described. FIG. 3 shows a flow chart diagram for explaining a method for designing the diffractive element 10 according to the present embodiment.

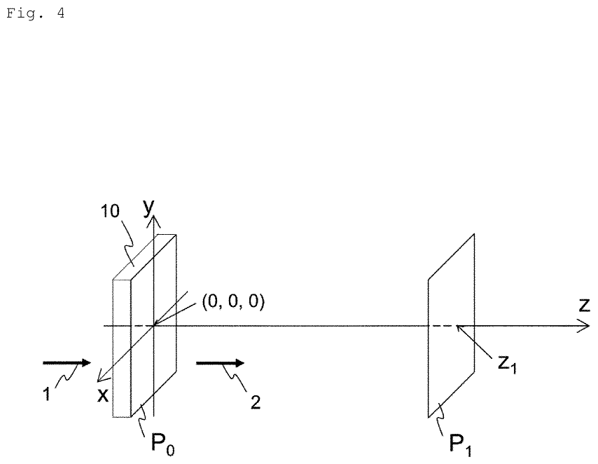

In the description of the method for designing the diffractive element 10 according to the present embodiment, as shown in FIG. 4, a plane P₁ parallel to the plane P₀ is disposed at a distance z₁ from the emission plane (plane P₀) of the diffractive element 10 including the origin of the xyz coordinate system and the origin (0, 0, 0).

First, φ_{B} is calculated by using a desired beam diameter 2r_{B} and equation (14). α=k sin φ_{B}, and β=k cos φ_{B} are calculated from the value of the φ_{B}. Here, k is the wave number of light (k=2π/λ, λ is the wavelength of the incident light or emission light in vacuum).

Next, when a collimated Gaussian beam having a radius Win is made incident on the diffractive element (DOE) 10 for realizing an optical path as shown in FIG. 2, the electric field distributions E_{Ax}(x, y) of emission light on the emission plane P₀ of the diffractive element 10 with respect to the incident light are calculated by equation (16) (step S11).

$$\begin{matrix}[ Math . 16 ] & \\ {E}_{Ax} ( x , y ) = {e}^{- {( \frac{{r}_{xy}}{{w}_{in}} )}^{2}} {e}^{j ( α {r}_{xy} )} & ( 16 )\end{matrix}$$

Here, r_{xy}=√(x²+y²). Further, Exp[j(αr_{xy})] indicates a phase distribution that realizes the optical path of FIG. 2.

The electric field distribution expressed by equation (16) is an electric field distribution in which light travels from an arbitrary coordinate point on the plane P0 toward the z-axis at an angle φ_{B}. The diffractive element in this case has the same function as the axicon lens.

Next, the electric field distribution E_{B,z1}(x, y) on the plane P₁ of the light propagated from the emission plane of the diffractive element 10 is calculated using Kirchhoff's diffractive integral by equations (17) to (21) (identical to equations (1) to (4)).

$$\begin{matrix}[ Math . 17 ] & \\ {E}_{B , {z}_{1}} ( x , y ) = \frac{j}{λ} \int {\int }_{- ∞}^{+ ∞} {E}_{Ax} ( x , y ) \cdot {g}_{z 1} ( {x}_{1} - {x}_{0} , {y}_{1} - {y}_{0} , {z}_{1} - {z}_{0} ) {dx}_{0} {dy}_{{}^{0}} & ( 17 )\end{matrix}$$

$$\begin{matrix}[ Math . 18 ] & \\ {g}_{{z}_{1}} ( x , y ) = \frac{1 + cos θ}{2} \cdot \frac{{e}^{- jkr}}{r} & ( 18 )\end{matrix}$$

$$\begin{matrix}[ Math . 19 ] & \\ r = \sqrt{{x}^{2} + {y}^{2} + {z}_{1}^{2}} & ( 19 )\end{matrix}$$

$$\begin{matrix}[ Math . 20 ] & \\ cos θ = \frac{{z}_{1}}{r} & ( 20 )\end{matrix}$$

Here, instead of equation (17), calculation may be performed using equation (21) using Fourier transform and inverse Fourier transform.

$$\begin{matrix}[ Math . 21 ] & \\ {E}_{B , {z}_{1}} ( x , y ) = {ℱ}^{- 1} [ ℱ [ {E}_{Ax} ( x , y ) ] ℱ [ {g}_{{z}_{1}} ( x , y ) ] ] & ( 21 )\end{matrix}$$

Here, g_{z1}(x, y) is an equation in which z of equation (2) is replaced with z₁.

The electric field distribution E_{B,z1}(x, y) on the plane P₁ obtained in this way is an approximate electric field distribution of a Bessel beam.

Therefore, in order to approximate the electric field distribution on the plane P₁ as that of a Bessel Gaussian beam, the product of Gaussian (Gaussian window) and E_{B,z1}(x, y) is calculated as shown in equation (22) (step S12).

$$\begin{matrix}[ Math . 22 ] & \\ {E}_{BG , {z}_{1}} ( x , y ) = {e}^{- {( \frac{{r}_{xy}}{w} )}^{2}} {E}_{B , {z}_{1}} ( x , y ) & ( 22 )\end{matrix}$$

Here, w is the radius of the Gaussian window (half the overall width (half value) that is 1/e of the Gaussian peak). In this way, the electric field distribution E_{BG,z1}(x, y) on the plane P₁ is calculated as the electric field distribution of a beam approximated by a Bessel Gaussian beam.

Next, for the electric field distribution E_{BG,z1}(x, y) on the plane P₁ shown in equation (22), the electric field distribution E_{BG,z=0}(x, y) on the plane P₀ (first electric field distribution) is calculated by equation (23) using inverse Fourier transform based on the principle of Kirchhoff's diffractive integral (step S13).

$$\begin{matrix}[ Math . 23 ] & \\ {E}_{BG , z = 0} ( x , y ) = {ℱ}^{- 1} [ \frac{ℱ [ {E}_{BG , {z}_{1}} ( x , y ) ]}{ℱ [ {g}_{{z}_{1}} ( x , y ) ]} ] & ( 23 )\end{matrix}$$

In Equation (23), if it can be approximated as g_{z1}(x, y)≈e^{-jkr}, E_{BG,z1}(x, y) are expressed as follows.

$$\begin{matrix}[ Math . 24 ] & \\ {E}_{BG , z} {=}_{0} ( x , y ) = {\int }_{- ∞}^{+ ∞} {E}_{BG , {z}_{1}} ( x , y ) \cdot {e}^{jkr} {dx}_{1} {dy}_{1} & ( {23}^{′} )\end{matrix}$$

$$Here ,$$

$$r = \sqrt{{( x - {x}_{1} )}^{2} + {( y - {y}_{1} )}^{2} + {z}_{1}}$$

The thickness L(x, y) of the diffractive element 10 is calculated for each coordinate (x, y) on the DOE emission plane from equations (24) and (25) (each identical to equations (10) and (11)), by using the electric field distribution E_{BG,z=0}(x, y) (first electric field distribution) on the DOE emission plane obtained in this way, and the surface structure (uneven shape) of the diffractive element 10 is designed (step S14).

$$\begin{matrix}[ Math . 25 ] & \\ d ( x , y ) = \frac{λ}{2 π ( {n}_{1} - {n}_{0} )} arg ( {E}_{BG , z = 0} ( x , y ) ) & ( 24 )\end{matrix}$$

Here, n₁ is a refractive index inside the diffractive element 10, n₀ is a refractive index outside the diffractive element 10, Δ is a wavelength in vacuum of the incident light or the emission light, and arg(E_{BG,z=0}(x, y)) is a deflection angle of the electric field distribution E_{BG,z=0}(x,y).

$$\begin{matrix}[ Math . 26 ] & \\ L ( x , y ) = {L}_{0} - d ( x , y ) & ( 25 )\end{matrix}$$

In the present embodiment, the electric field distribution on the emission plane of the diffractive element is derived on the basis of Bessel Gaussian beam to design the surface structure (unevenness structure) of the diffractive element. Accordingly, the diameter and power of the bright line can be maintained to be substantially equal in a predetermined length (range) in the light propagation direction (z-direction). Here, “substantially equal” includes the same, and may be a range that can realize the accuracy required for laser processing using a beam, rust removal, and the like. For example, as described below, the beam diameter may vary by a factor of about 1.5 times, such as 30 μm to 40 μm, or the normalized beam power density may vary by a factor of 5 times or less. If this level of normalized beam power is used, for example, when the total power of the light emitted from the DOE emission plane is about 100 W which is a normally used rust removal laser power, rust removal is possible. The “standardized beam power density” is a beam power density when the total power of DOE emission light is 1 W.

### <Method for Manufacturing Diffractive Element>

The diffractive element 10 is manufactured on the basis of the surface structure of the diffractive element designed as described above. The diffractive element 10 is made of a plate member of a transparent material such as ZnS or quartz. The surface structure of the designed diffractive element 10 is formed on the surface of the plate member by known fine processing. Thus, the diffractive element 10 according to the present embodiment is manufactured.

### <Effect>

The effects of the method for designing the diffractive element and the method for manufacturing the same according to embodiments of the present embodiment of the present invention will be described.

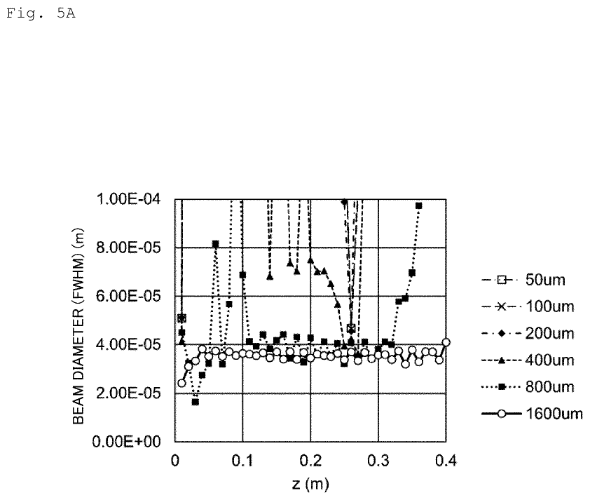

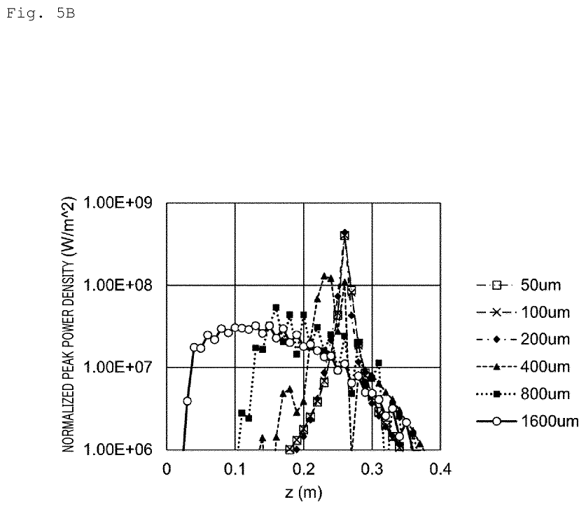

FIG. 5A shows the simulation results of the beam diameter of the light intensity distribution of light beam (square of electric field strength) when the overall width of the Gaussian window (diameter in which the power density is 1/e² of the peak power density) 2w is changed, in the light beam generated by the electric field distribution E_{BG,Z=0} on the emission plane of the diffractive element (DOE) 10. FIG. 5B shows the simulation results of the peak power density (maximum power density) of the light intensity distribution of light beam.

In the simulation of the light intensity distribution of light beam, the electric field distribution E_{BG,Z=0} on the DOE emission plane was calculated by equations (13) to (23). The light intensity distribution of light beam in the image formation was calculated on the basis of equation (1), using the electric field distribution E_{BG,Z=0}.

In this simulation, the definition in the x-axis direction and the y-axis direction is 5 μm.

The beam incident on the diffractive element (DOE) 10 and the lens used in the simulation was a Gaussian beam with a diameter of 5.1 mm (a diameter at which the power density is 1/e² of the peak power density).

Further, the overall width at half maximum 2r_{B} of the main lobe of the first type zero-order Bessel beam was set to 35 μm (φ_{B} is 3 mrad). The wavelength λ of the light was 1070 nm.

In the drawing, the “distance z” on the horizontal axis is a distance from the DOE emission plane. The “normalized peak power density” on the vertical axis is a peak power density when the total power of DOE emission light is 1 W.

Although the “beam diameter” of the vertical axis is usually a diameter which becomes a power density of 1/e² of the peak power density, because the light intensity distribution of light beam determined by the electric field distribution u₀ on the DOE emission plane in the present embodiment is not a Gaussian type, the overall width at half maximum (FWHM) was used.

The overall width 2w of the Gaussian window was varied at 50 μm, 1600 μm.

As shown in FIG. 5A, when the overall width 2w of the Gaussian window is 50 μm to 400 μm, the beam diameter is about 40 μm only when z is near 0.25 m. On the other hand, when the overall width 2w of the Gaussian window is 800 μm, the beam diameter is held by the length of 0.2 m between 0.1 m and 0.3 m in the range of about 30 μm to 42 μm of a beam diameter change. Also, when the overall width 2w of the Gaussian window is 1600 μm, the beam diameter is held in a range of 0.4 m or more of a length (a range of o to 0.4 m or more) in a range of about 30 μm to 40 μm of a beam diameter change.

As shown in FIG. 5B, when the overall width 2w of the Gaussian window is 50 μm 200 μm, the peak power density is about 5E8 W/m² only when z is near the vicinity of 0.25 m. On the other hand, when the overall width 2w of the Gaussian window is 400 μm, the range in which the peak power density fluctuation falls within about 5 times (about 2E7 to 1E8 W/m²) is about the length of 0.04 m between z=0.22 m and 0.26 m. Furthermore, when the overall width 2w of the Gaussian window is 800 μm, the range in which the peak power density fluctuation falls within about 5 times (about 1E7 to 5E7 W/m²) is about the length of 0.18 m between z=0.12 m and 0.3 m. Furthermore, when the full width 2w of the Gaussian window is 1600 μm, the range in which the peak power density fluctuation falls within about 5 times (about 1E7 to 5E7 W/m²) is about the length of 0.21 m between z=0.04 m and 0.25 m.

In this way, the beam diameter and the peak power density are maintained at a long distance in the z-axis direction as the width of the Gaussian window increases. By changing the width of the Gaussian window, it is possible to change the beam diameter and the length of the power density which can be held in the z-axis direction.

### <Effect>

When a Bessel beam is applied to a conventional method for designing a diffractive element, since the Bessel beam has a constant beam diameter and intensity in an infinite range, the beam power does not attenuate, and therefore, there is a possibility that the Bessel beam is irradiated to a region other than a desired range. As a result, there is a problem that a desired shape cannot be processed, or there is a risk that an object other than the processing and rust removal object or a human body is irradiated with the light.

In the diffractive element designed and manufactured in the present embodiment, the beam diameter and intensity can be limited to be constant in a finite range, and only a desired region can be irradiated with light. Therefore, the desired shape can be processed, and the safety can be secured without irradiating an object other than the processing and rust removal object or a human body.

Since the diffractive element designed and manufactured in the present embodiment can hold the diameter and power of the emission light within a desired range in the propagation direction (z-direction) of the light, it is possible to perform the processing, rust removal and the like with high accuracy on an object having a depth by the emission light (laser beam).

Further, the diffractive element designed and manufactured in the present embodiment is small and light (about several tens of grams), and the head portion of the laser processing device can be made smaller and lighter than the conventional mechanism.

### Second Embodiment

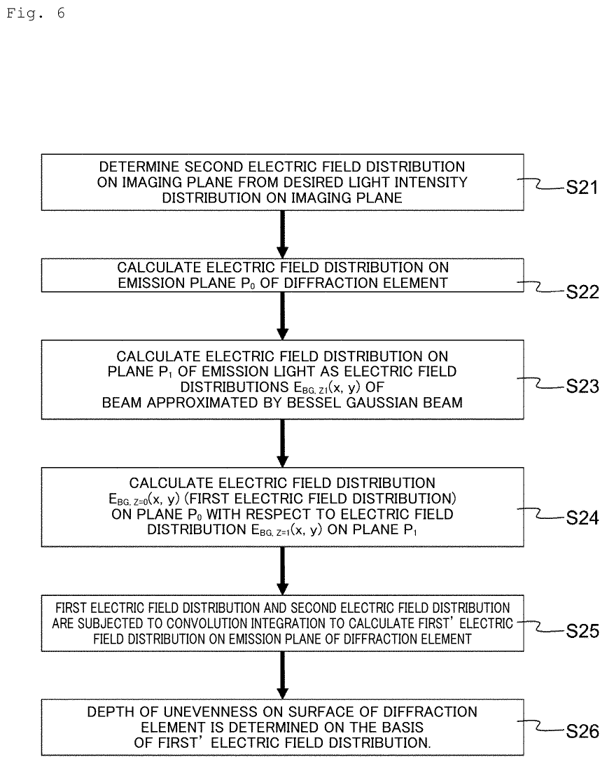

A method for designing a diffractive element and a method for manufacturing the same according to a second embodiment of the present invention will be described with reference to FIG. 6.

In the first embodiment, a diffractive element on which a bright spot is imaged was shown as an example. In the present embodiment, a diffractive element that forms a desired image will be explained as an example.

In the present embodiment, a diffractive element (DOE) 20 for forming a two-dimensional shape on the imaging plane will be described. The diffractive element 20 performs phase modulation so that light emitted from the emission plane in a first′ electric field distribution has an intensity distribution of a second electric field distribution corresponding to a desired light intensity distribution on the imaging plane.

FIG. 6 shows a flow chart diagram for explaining a method for designing the diffractive element 20 according to the present embodiment.

First, the light intensity distribution imaged on the imaging plane P₁ is defined as q(x, y). The electric field intensity at this time becomes √q(x, y), but the electric field distribution (second electric field distribution) having this electric field intensity is defined as uₑ(x,y) (step S21). For example, in uₑ(x, y), when the real part of the electric field is √q(x, y) and the imaginary part is 0, uₑ(x, y)=√q(x, y)+j·0 may be established. Here, j represents the imaginary unit.

Next, similarly to steps S11 to S13 in the first embodiment, a first electric field distribution E_{BG,z=0}(x, y) is calculated (steps S22 to S24).

Next, the electric field distribution E_{BG,z=0,1} (first′ electric field distribution) on the DOE emission plane is calculated by performing convolution integration of the first electric field distribution E_{BG,z=0}(x, y) and the second electric field distribution uₑ(x,y), as shown in equation (26) (step S25).

$$\begin{matrix}[ Math . 27 ] & \\ {E}_{BG , z = 0 , l} = \int {\int }_{S} {u}_{c} ( ξ , η ) {E}_{BG , z = 0} ( x - ξ , y - η ) d ξ d η & ( 26 )\end{matrix}$$

Here, S represents an integration range, and a range on the DOE emission plane or a range including the DOE emission plane is considered.

Here, the shape represented by uₑ(x, y) may be a bright spot as shown in the first and second embodiments. Therefore, the electric field distribution E_{BG,z=0,1}(x, y) on the DOE emission plane in the present embodiment is the same as the electric field distribution E_{BG,z=0}(x, y) on the DOE emission plane in the first embodiment.

The depth d(x, y) of the unevenness on the surface of the diffractive element 20 is calculated by equation (27), using the electric field distribution E_{BG,z=}0,1(x, y) on the DOE emission plane obtained in this way.

$$\begin{matrix}[ Math . 28 ] & \\ d ( x , y ) = \frac{λ}{2 π ( {n}_{1} - {n}_{0} )} arg ( {E}_{BG , z = 0 , l} ( x , y ) ) & ( 27 )\end{matrix}$$

Here, n₁ is the refractive index inside the diffractive element 20, no is the refractive index outside the diffractive element 20, λ is the wavelength of the incident light or emission light in vacuum, arg(E_{BG,z=0,1}(x, y)) is the deflection angle of the electric field distribution E_{BG, z=0,1}(x,y).

The thickness L(x, y) of the diffractive element 20 is calculated for each coordinate (x, y) on the DOE emission plane by equation (25) using d(x, y) to design the surface structure (unevenness shape) of the diffractive element 20 (step S26).

The diffractive element 20 is manufactured in the same manner as in the first embodiment, on the basis of the surface structure of the diffractive element 20 designed in this manner.

Further, in the present embodiment, if uₑ(ξ, η) is a line segment, a line segment image is formed when removing rust using a laser, and by moving the image perpendicular to the line segment, rust can be removed as a surface.

As described above, according to the present embodiment, it is possible to keep the diameter and power of the light beam emitted from the diffractive element to be substantially equal within a predetermined length (range) in the light propagation direction (z-direction), by deriving the electric field distribution on the emission plane of the diffractive element and designing the surface structure (unevenness structure) of the diffractive element, on the basis of convolution integration of the total value of the electric field distributions on the diffractive element for imaging each bright spot of the bright line within a predetermined range of a straight line passing through the diffractive element (the electric field distribution on the diffractive element emission plane for generating the bright line) and the electric field distributions of various shapes.

Therefore, since the diffractive element manufactured in the present embodiment can hold the diameter and power density of the emission light at a desired length in the propagation direction (z-direction) of the light, processing, rust removal or the like can be performed on the object having a depth with high accuracy in various shapes by the emission light (laser beam), and the same effect as that of the first embodiment can be obtained.

In the embodiment of the present invention, the emission light from the diffractive element is condensed in a direction parallel to the optical axis, but the present invention is not limited thereto, but may be on an axis substantially parallel to the optical axis instead of on an axis parallel to the optical axis. The “substantially same axis” may be within a range in which accuracy necessary for laser beam machining using a beam, rust removal, and the like can be realized.

In the embodiment of the present invention, the diffractive element is designed using a computer.

In the embodiment of the present invention, an example of the structure, dimensions, material, and the like of each constituent part is shown in the configuration of the diffractive element, the manufacturing method, and the like, but the present invention is not limited thereto. Any material can be used as long as it exhibits the function of a diffractive element and produces an effect.

### INDUSTRIAL APPLICABILITY

Embodiments of the present invention relates to a method for designing a diffractive element and a method for manufacturing the same in a high power laser device, and is applicable to processing and rust removal by a laser beam.

### REFERENCE SIGNS LIST

10 Diffractive element

1-5. (canceled)

6. A method for designing a diffractive element for modulating a phase of incident light, using a computer, the method comprising:
calculating an electric field distribution of an emission light on an emission plane of the diffractive element with respect to the incident light, the incident light being a Gaussian beam;
calculating an electric field distribution obtained by multiplying an electric field distribution of emission light from the emission plane by a Gaussian window in a plane parallel to the emission plane located at a predetermined distance from the emission plane, as an electric field distribution of a beam approximated by a Bessel Gaussian beam;
calculating a first electric field distribution as an electric field distribution on the emission plane of the diffractive element with respect to the electric field distribution of the emission light on the plane, on the basis of a principle of Kirchhoff's diffractive integral; and
determining a depth of an unevenness on a surface of the diffractive element, on the basis of the electric field distribution on the emission plane of the diffractive element.

7. The method for designing the diffractive element according to claim 6, further comprising:
calculating a second electric field distribution in which a positive square root of the light intensity distribution imaged on the plane is set as an intensity; and
calculating an electric field distribution on the emission plane of the diffractive element according to a convolution integral of the second electric field distribution and the first electric field distribution.

8. The method for designing the diffractive element according to claim 6,
wherein in a Cartesian coordinate system in which the emission plane is orthogonal to a z-axis,
when calculating the electric field distribution of the emission light on the emission plane of the diffractive element, an electric field distribution E_{Ax}(x, y) on the emission plane with respect to the incident light is calculated using equation (A), and
when calculating the electric field distribution obtained by multiplying the electric field distribution of emission light from the emission plane, an electric field distribution E_{BG, z1}(x, y) of the emission light on the plane is calculated by equation (B), using an electric field distribution E_{B, z1}(x, y) calculated using a diffractive integral of Kirchhoff.
$${E}_{Ax} ( x , y ) = {e}^{- {( \frac{{r}_{xy}}{{w}_{in}} )}^{2}} {e}^{j ( {ar}_{xy} )} \qquad ( A )$$
wherein, r_{xy}=\sqrt{ }(x²+y²), win is a radius of a Gaussian beam,
α=k sin φ_{B}, moreover, φ_{B} is represented by following equation,
$${φ}_{B} = {sin}^{- 1} \frac{2.252728}{2 {r}_{B} k} = {sin}^{- 1} \frac{2.252728}{4 {r}_{B} π} λ$$
here, 2r_{B} is a diameter of a Bessel beam, k is a wavenumber of the incident light or the emission light,
λ is a wavelength of the incident light or the emission light in the vacuum.
$${E}_{BG , {z}_{1}} ( x , y ) = {e}^{- {( \frac{{r}_{xy}}{w} )}^{2}} {E}_{B , {z}_{1}} ( x , y ) \qquad ( B )$$
Here, w is a radius of the Gaussian window.

9. The method for designing the diffractive element according to claim 6,
wherein a depth d(x, y) of unevenness on a surface of the diffractive element is expressed by equation (C).
$$d ( x , y ) = \frac{λ}{2 π ( {n}_{1} - {n}_{0} )} arg ( {E}_{BG , z = 0 , l} ( x , y ) ) \qquad ( C )$$
here, n₁ is a refractive index inside the diffractive element, no is a refractive index outside the diffractive element, λ is a wavelength in a vacuum of the incident light or the emission light, and arg(E_{B,z=0,1}(x, y) is a deviation angle of the electric field distribution on the emission plane of the diffractive element.

10. A method for manufacturing a diffractive element comprising the method for designing the diffractive element according to claim 6.

11. The method for designing the diffractive element according to claim 7,
wherein in a Cartesian coordinate system in which the emission plane is orthogonal to a z-axis,
when calculating the electric field distribution of the emission light on the emission plane of the diffractive element, an electric field distribution E_{Ax}(x, y) on the emission plane with respect to the incident light is calculated using equation (A), and
when calculating the electric field distribution obtained by multiplying the electric field distribution of emission light from the emission plane, an electric field distribution E_{BG,z1}(x, y) of the emission light on the plane is calculated by equation (B), using an electric field distribution E_{B,z1}(x, y) calculated using a diffractive integral of Kirchhoff.
$${E}_{Ax} ( x , y ) = {e}^{- {( \frac{{r}_{xy}}{{w}_{in}} )}^{2}} {e}^{j ( {ar}_{xy} )} \qquad ( A )$$
wherein, r_{xy}=\sqrt{ }(x²+y²), win is a radius of a Gaussian beam,
α=k sin φ_{B}, moreover, φ_{B} is represented by following equation,
$${φ}_{B} = {sin}^{- 1} \frac{2.252728}{2 {r}_{B} k} = {sin}^{- 1} \frac{2.252728}{4 {r}_{B} π} λ$$
here, 2r_{B} is a diameter of a Bessel beam, k is a wavenumber of the incident light or the emission light,
λ is a wavelength of the incident light or the emission light in the vacuum.
$${E}_{BG , {z}_{1}} ( x , y ) = {e}^{- {( \frac{{r}_{xy}}{w} )}^{2}} {E}_{B , {z}_{1}} ( x , y ) \qquad ( B )$$
Here, w is a radius of the Gaussian window.

12. The method for designing the diffractive element according to claim 7,
wherein a depth d(x, y) of unevenness on a surface of the diffractive element is expressed by equation (C).
$$d ( x , y ) = \frac{λ}{2 π ( {n}_{1} - {n}_{0} )} arg ( {E}_{BG , z = 0 , l} ( x , y ) ) \qquad ( C )$$
here, n₁ is a refractive index inside the diffractive element, n₀ is a refractive index outside the diffractive element, λ is a wavelength in a vacuum of the incident light or the emission light, and arg(E_{B,z=0,1}(x, y)) is a deviation angle of the electric field distribution on the emission plane of the diffractive element.

13. The method of claim 7 further comprising:
manufacturing the diffractive element.

14. The method of claim 13, wherein manufacturing the diffractive element comprises:
forming a plate member of a transparent material;
designing a surface structure of the diffractive element based on the calculated electric field distribution on the emission plane of the diffractive element; and
forming the designed surface structure on a surface of the plate member using fine processing to create the unevenness on the surface of the diffractive element.

15. The method of claim 14, wherein the transparent material of the plate comprises of ZnS or quartz.
